(19) United States
(12) Patent Application Publication
(10) Pub. No.: US 2003/0208550 A1
(43) Pub. Date: Nov. 6, 2003

(54) Method to provide direct system storage access within a notebook computer via a wireless interconnect and a low power high-speed data management bus while the main CPU is idle

(76) Inventors: Tony G. Hamilton, Durham, NC (US); Marc TheBerge, Fuquay Varina, NC (US)

Correspondence Address: BLAKELY, SOKOLOFF, TAYLOR & ZAFMAN LLP, Seventh Floor, 12400 Wilshire Boulevard, Los Angeles, CA, 90025-1026, US

(21) Appl. No.: 09/896,563

(22) Filed: Jun. 28, 2001

(51) Int. Cl. G06F 15/16; G06F 15/167; G06F 17/30; G06F 7/00

(52) U.S. Cl. 709/212; 709/230; 707/10

(57) ABSTRACT

A system and method for allowing direct storage access to a notebook computers resources. The system predetermines an environment given to a wireless enabled notebook, determines if the notebook has been moved, determines if the environment has been classified, determines a system end user's identification and determines if data to be transferred has been buffered. In addition, this method matches system resources to data to be translated, executes the data transfer and returns the resources to an idle state.

### FIELD OF THE INVENTION

The invention generally relates to wireless network environments, and more particularly relates to a system and method of providing direct storage access to system resources located in a wireless network environment.

### BACKGROUND

In the past decade, mobile computing and communications devices have become essential productivity tools. The popularity of theses devices have risen as their cost and their sizes have diminished. It is now routine for business travelers to carry mobile computers, mobile phones and personal data assistants. This technology is increasingly relied upon to facilitate the connection of personal and business mobile devices. The advent of the Blue tooth and 802.11a technologies promises to accelerate this renaissance by providing wireless devices that have improved data rates, lower power requirements, and which utilize broadband transmission.

With the adoption and acceptance of wireless networking environments such as 802.11a, bluetooth and cellular combined with the evolution of networking infrastructure intelligence it is now possible for data to follow and understand the location of its assigned owner. Such a capability would allow system end users to remotely perform such tasks as updating their e-mail notes or downloading important web pages and voicemail messages. Presently available systems do not allow system end users to remotely communicate with networking infrastructures in this manner.

Another drawback of such systems is their heavy reliance on limited power resources. What is needed, therefore, is a system and method which facilitates the desired communication while preserving system power resources.

### BRIEF DESCRIPTION OF THE DRAWINGS

The present invention is illustrated by way of example and not limitation in the figures of the accompanying drawings, in which like references indicate similar elements and in which:

FIG. 1 illustrates one embodiment of the system architecture of the present invention.

FIG. 2 shows an exemplary process for providing direct system storage access via a wireless interconnection according to one embodiment of the present invention.

FIG. 3 shows a data storage process in accordance with one embodiment of the current invention.

FIG. 4 is a table which lists exemplary data transfer capabilities of various transfer mechanisms in various environments.

FIG. 5 depicts an exemplary processing system with which the present invention may be implemented.

### DETAILED DESCRIPTION

The method and system of the present invention relates to a PC architectural design which allows access to notebook computer's resources via a wireless interconnect infrastructure. A microcontroller located within the notebook operates to put a storage medium within the notebook into a low power data acceptance mode. The important features of the notebook's design is its use of a low power data bus along with its handshaking commands and defined application stack.

The emergence of Wireless Networking Environments such as 802.11a, Bluetooth and Cellular along with the evolution of networking infrastructure intelligence, promises to make it possible to allow data to follow and understand the location of its assigned owner. The architectural method described herein demonstrates how such data may be stored directly onto storage mediums within a notebook computer, and be processed either automatically or by end user command. This mobile architectural feature enhances the end user experience of Notebooks design and provides the device added range and flexibility.

The usage scenario for this architecture is as follows: a notebook in its very deepest sleep state may have its system storage resources (assuming permission by the end user has been granted) used to store or remove data via a wireless network infrastructure and a low level data/command/management bus. Within a specific wireless setting a user would be recognized via its Bluetooth/PAN or wireless LAN infrastructure. Systems resources would then be allocated according to a users setting explicitly directing how access is to be granted to the notebook. Power resource conditions and some level of intelligence as to how long the user is to be within the recognized environment are key in these determinations. Finally, a download of key information may be stored within the environment and downloaded into the notebooks storage areas such as its hard drive, Flash Card or Read/Write CD ROM.

The categories of information downloaded may include e-mail summaries, important Web pages or voicemail messages. In another embodiment, any downloadable information deemed desirable by the end user may be downloaded.

In one embodiment, as previously mentioned, data flowing over the aforementioned wireless link may be detected by an internal system microcontroller. The microcontroller, by means of a data/command/management bus identifies available storage devices within the notebook and directs power to them while facilitating information transfers thereto. The information is transferred and may be tagged for recognition so that the files may be easily accessed once the laptop is fully awake and operational.

In one embodiment the aforementioned system may be implemented according to serial ATA (advanced technology attachments) drive specifications. Such an arrangement may enhance system performance by ensuring the compliance of all notebook storage mediums with ATA drive standards. As mentioned previously, the accessing of these devices are controlled by a system microcontroller. Special commands within the microcontroller Device facilitates data collection over the wireless link and ascertain by means of timestamps and resource power capabilities what data to accept or transmit.

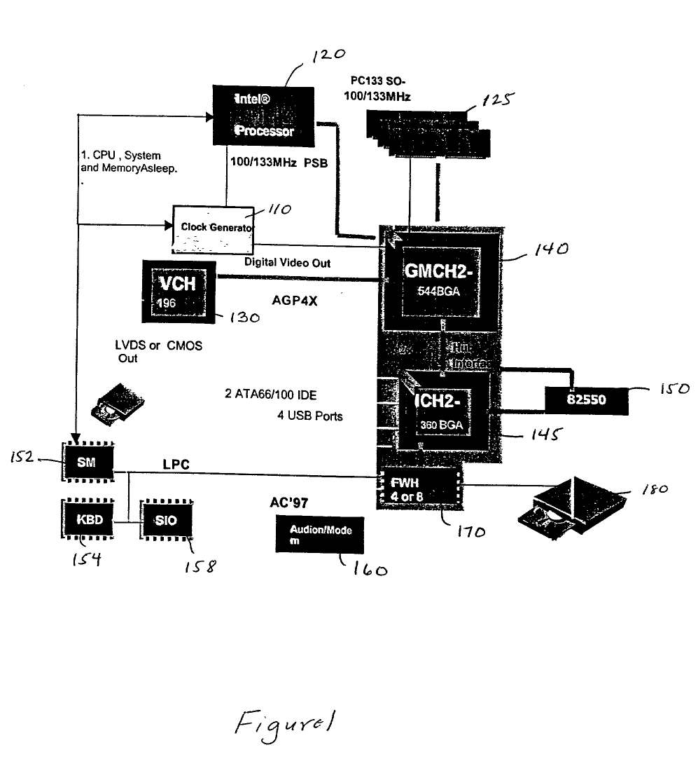

FIG. 1 illustrates one embodiment of the system architecture of the present invention. Referring to FIG. 1, there is shown clock generator 110, CPU 120, video memory 125, controller hub 130, graphics memory controller hub 140, input/output controller hub 145, Ethernet controller 150, system management controller 152, keyboard device 154, system output controller 158, audio modem 160, firmware hub (FWH) 170 and CD-ROM storage device 180. Clock generator 110 generates clock timing signals for this device.

The processor 120 provides the data processing power for the device. The processor executes the instructions provided by program applications located in system memory 125.

Video controller hub 130 controls digital video transmissions. This device communicates with graphics memory controller hub 140, which provides interfaces to other system components (such as memory 125, processor 120, storage devices 180, the Ethernet controller 150, etc.)

The input/output controller hub 145 controls communications transmitted into and out of the device. This circuitry provides an output to an Ethernet controller device 150, which facilitates device communication with the Ethernet.

Firmware hub (FWH) 170 contains applications which are programmed to ascertain the class of services that are currently available and to allow the wireless transfers to take place.

System management controller 152 contains a microcontroller. This device remains awake while main CPU 120 is idle and facilitates the accessing of available storage mechanisms. This device may utilize a wakeup interrupt which periodically activates the device as a part of its monitoring process. Once activated, it may detect when a toggle has been transmitted over a dedicated line of a device trying to gain storage access. This information is used to set into motion the storage accessing processes described herein.

Also shown is keyboard device 154, system output controller 158, and audio modem 160. Keyboard device 154 and system output controller 158 which respectively facilitate data input and data output may be implemented using conventional computer technologies. The audio modem, which controls the device speakers and facilitates device connection to phone lines, may also be implemented using conventional technologies.

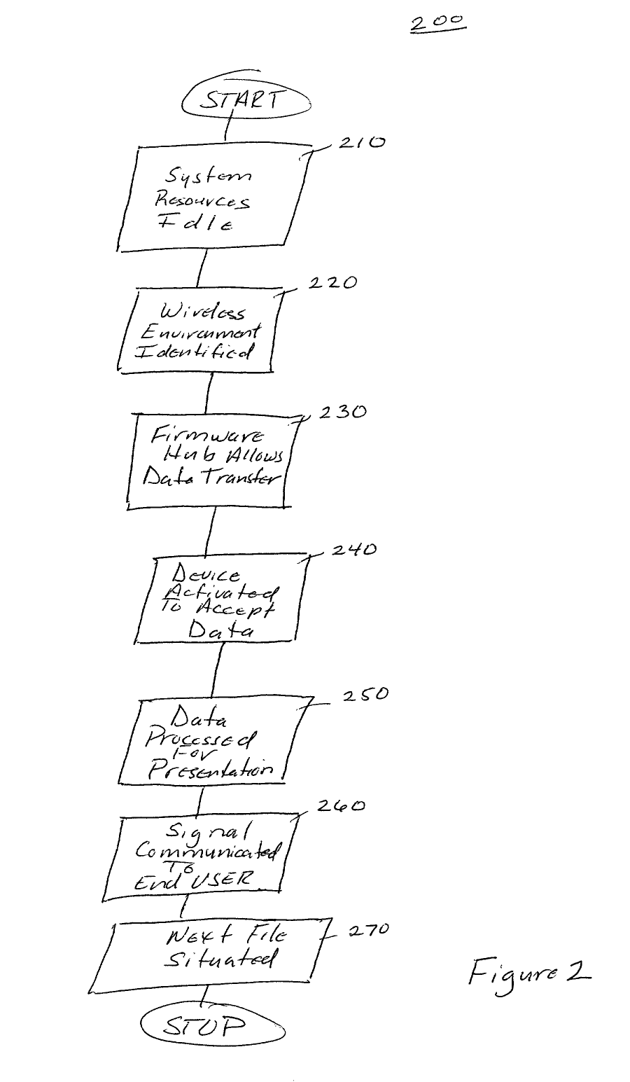

FIG. 2 shows an exemplary process 200 for providing direct system storage access via a wireless interconnection according to one embodiment of the present invention. Referring to FIG. 2, in operation 210, the CPU, system and memory are idle. At this point, the system has not been activated, but is poised for activation upon the detection of a toggle from a source seeking storage access.

At operation 220, the wireless environment is identified. As mentioned earlier, this may be by a Bluetooth, PAN or other wireless LAN.

At operation 230 the FWH allows data transfer. As mentioned earlier, the level of information transferred may include email summaries, important web pages or voicemail messages.

At operation 240 the device is activated to accept the data. The once idle storage device is activated so that the data transfer may be completed, and the transmitted information stored in the storage device.

At operation 250 the data is processed for presentation. When the storage operation 240 is completed, a register in the firmware chip set is alerted that data is available for processing. This processing is defined by system settings (i.e. MP3 decode, RX system configured to wakeup the operating system and associated application for formatting data into a form useful for viewing).

At operation 260 a signal indicating the receipt of the transmitted data is communicated to the system end user. The signal is sent back to the infrastructure, indicating that the data has been received, discarded or stored for future use.

At operation 270, the next file is situated for storage. This is done if the environment and Notebook power can accommodate the incoming data.

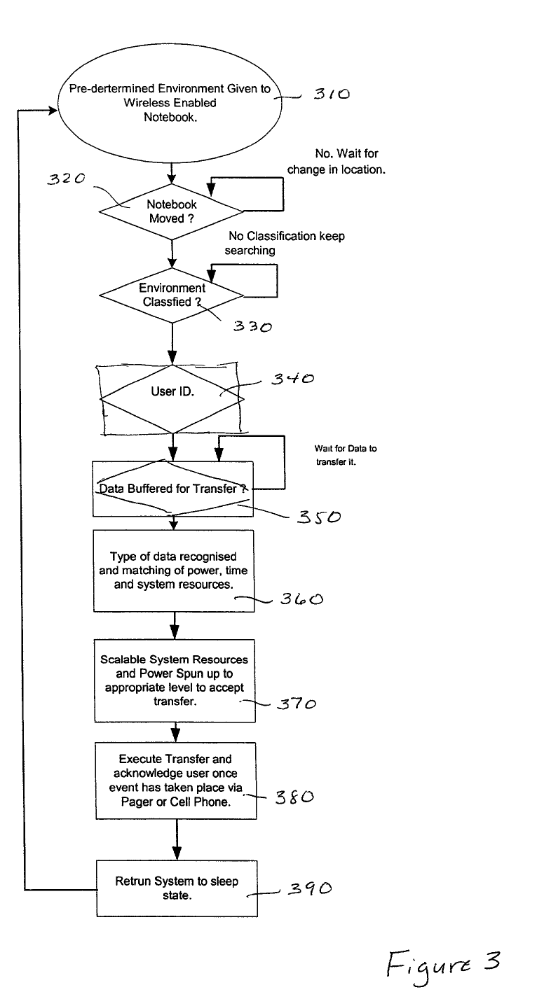

FIG. 3 shows a data storage process in accordance with one embodiment of the current invention. At operation 310, a predetermined environment is given to the wireless enabled notebook.

At operation 320, it is determined if the notebook has been moved. If the notebook has not moved the system management controller continues to monitor the predetermined environment's storage access queries.

At operation 330, it is determined whether or not the environment is classified. If the notebook has been moved the system management controller must ascertain the new environment classification. The classification identifies the environment and enables the initiation of the transfer of data to and from the environment.

At operation 340, the user ID is determined. The user ID identifies the user and enables the user to access files or initiate data transfers.

At operation 350, it is determined if the data has been buffered for transfer. If the data has been buffered, the system may begin execution of the data transfer process.

At operation 360, the type of data seeking access is recognized and a matching of power, time and resources is facilitated. This operation determines which class of service is available. Based on this determination, the data may be accepted and the data transfer allowed to take place.

At operation 370, available system resources and power are brought up to a level necessary to accommodate the data. This involves the activation of a storage device, so that the data may be accepted and provided the necessary amount of storage space.

At operation 380, the transfer process is completed. The completion of the process may be acknowledged and communicated to the system end user. This communication may be transmitted by pager or cell phone. It should be noted that the execution of the transfer is facilitated by an operating system and associated application that formats data to be transferred into a format relevant and useful to the system end user.

At operation 390, the utilized system resources are returned to their idle state. However, the system management controller continues to monitor the incoming data for possible transfer.

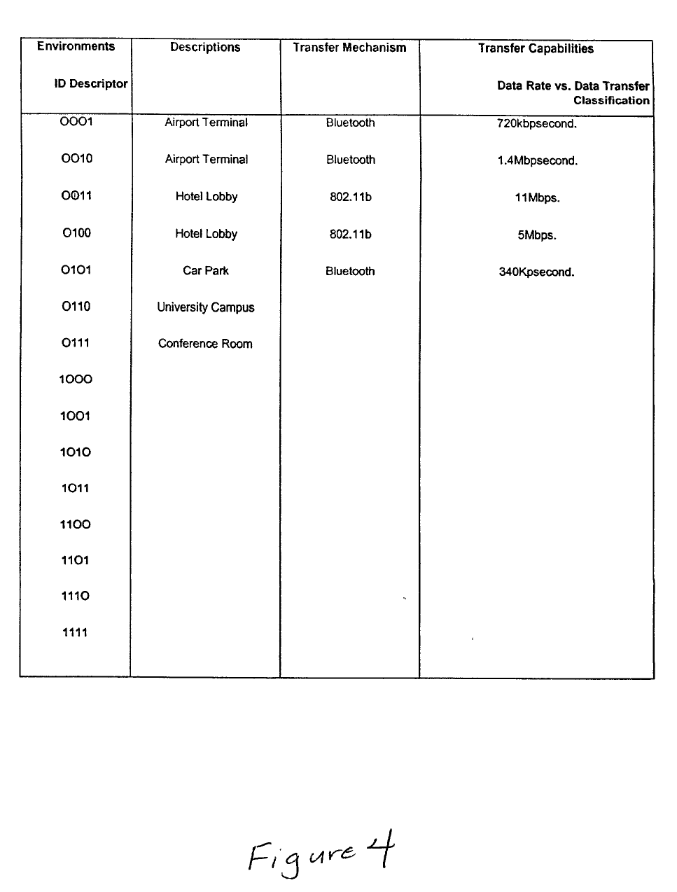

FIG. 4 is a table which lists exemplary data transfer capabilities of various transfer mechanisms in various environments. It should be noted that the variance in the transfer capabilities shown for similar devices in similar environments is attributable to the varying capabilities of the specific devices and environments listed. Each environment ID descriptor represents a specific individual environment.

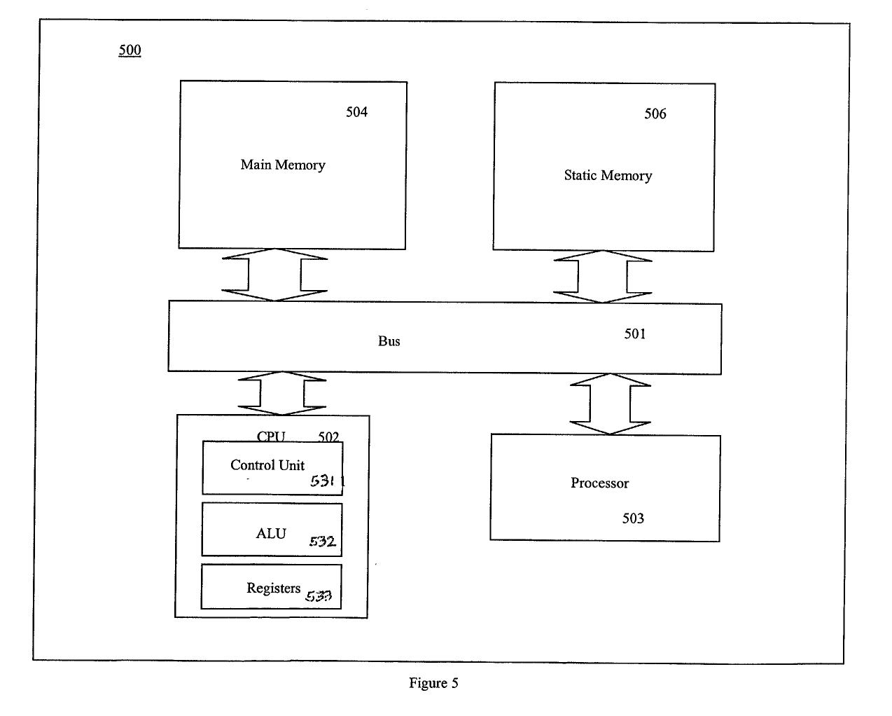

FIG. 5 depicts an exemplary processing system 500, with which the present invention may be implemented. In one embodiment, the storage accessing operations may be executed using a general processing architecture. Referring to FIG. 5, the processing system may include a bus 501 or other communication means for communicating information, and a central processing unit (CPU) 502 coupled to the bus for processing information. CPU 502 includes a control unit 531, an arithmetic logic unit (ALU) 532, and registers 533. CPU 502 can be used to implement the network jitter reducing functions described herein. Furthermore, another processor 503 such as, for example, a co-processor, may be coupled to the bus 501 for additional processing power and speed.

The processing system 500 also includes a main memory 504 which may be a random access memory (RAM) device, that is coupled to the bus 501. The main memory stores information and instructions to be executed by CPU 502. The main memory also stores temporary variables and other intermediate information during the execution of instructions by CPU 502. The processing system also includes a static memory 506, for example a read only memory (ROM) and/or other static device, that is coupled to the bus for storing static information and instructions for CPU 502.

In addition, the methods that are described above may be stored in the memory of a computer system as a set of instructions to be executed. The instructions to perform the methods as described above could alternatively be stored on other forms of computer readable mediums including magnetic and optical disks. For example, the method of the present invention can be stored on computer readable mediums, such as magnetic disks or optical disks that are accessible via a disk drive (or computer readable medium drive).

In the foregoing specification, the invention has been described with reference to specific exemplary embodiments thereof. It will however, be evident that various modifications and changes may be made thereto without departing from the broader spirit and scope of the invention as set forth in the appended claims. The specifications and drawings are, accordingly, to be regarded in an illustrative rather than a restrictive sense.

What is claimed is:

1. A method for providing direct storage access within a notebook computer comprising:
predetermining an environment given to a wirelessly enabled notebook;
determining if the notebook has been moved to a second environment;
determining if the second environment has been classified;
determining the notebook's user's identification;
determining if data to be transferred to the notebook has been buffered;
matching notebook resources to accommodate the data to be transferred;
executing the data transfer; and
returning notebook resources to an idle state.

2. The method of claim 1, wherein a system time resource is apportioned according to the data received in a data transfer.

3. The method of claim 1, wherein a system power resource is apportioned according to the data received in the data transfer.

4. The method of claim 1, wherein the user is notified of the data transfer after the notebook is returned to an idle state.

5. The method of claim 4 wherein the user is notified via a pager.

6. The method of claim 4 wherein the user is notified via a cell phone.

7. A device for providing direct storage access within a notebook computer comprising:
a processor;
a clock generator;
a main CPU;
a graphical memory controllable hub;
a video controller hub;
a firmware hub;
an input/output controller hub; and
a system management controller that controls access to the notebook while the main CPU is idle.

8. The device of claim 7, wherein the system management controller comprises interrupt circuitry.

9. The device of claim 7, wherein the system management controller utilizes a data/command/management bus.

10. The device of claim 7, wherein the system management controller awakens an idle storage device and allows a data transfer to take place.

11. A machine-readable medium having stored thereon a set of instructions, which when executed, perform a method comprising:
predetermining an environment given to a wirelessly enabled notebook;
determining if the notebook has been moved to a second environment;
determining if the second environment has been classified;;
determining the notebook's user's identification;
determining if data to be transferred to the notebook has been buffered;
matching notebook resources to accommodate the data to be transferred;
executing the data transfer; and
returning the notebook to an idle state.

12. The machine-readable medium of claim 11, wherein a system time resource is apportioned according to the data received in a data transfer.

13. The machine-readable medium of claim 11, wherein a system power resource is apportioned according to the data received in the data transfer.

14. The machine-readable medium of claim 11, wherein the user is notified of the data transfer after the notebook is returned to an idle state.

15. The machine-readable medium of claim 14, wherein the user is notified via a pager.

16. The machine-readable medium of claim 14, wherein the user is notified via a cell phone.
